(19) United States
(12) Patent Application Publication
(10) Pub. No.: US 2009/0035055 A1
(43) Pub. Date: Feb. 5, 2009

(54) Coupling device for connecting pipes and vehicle with a coupling device of this type

(75) Inventors: Thomas Rosch, Linsengericht (DE); Werner Hempel, Nidderau (DE); Stefan Eich, Jossgrund (DE); Wolfgang Gunther, Gedern (DE)

Correspondence Address: BUCHANAN, INGERSOLL & ROONEY PC, POST OFFICE BOX 1404, ALEXANDRIA, VA, 22313-1404, US

(73) Assignee: Veritas Ag, Gelnhausen (DE)

(21) Appl. No.: 11/666,873

(22) PCT Filed: Sep. 9, 2005
(86) PCT No.: PCT/EP05/09731

§ 371 Date: Mar. 4, 2008

(30) Foreign Application Priority Data
Nov. 5, 2004 (DE) 102004053538.08

(51) Int. Cl. F16D 1/04

(52) U.S. Cl. 403/314

(57) ABSTRACT

The invention relates to a coupling device for the connection of pipes to a retaining device, which has an outer part and an inner part arranged in the outer part. This coupling device is characterised in that the outer part and the inner part can move relative to one another and in the longitudinal direction of the retaining device between a locking position and a release position, wherein at least one wedge surface, arranged sloping with respect to the longitudinal axis of the retaining device, is provided on the outer part, which interacts with at least one complementarily formed wedge surface, which is provided on the inner part.

The invention relates to a coupling device for connecting pipes to a retaining device, which comprises an outer part and an inner part arranged within the outer part, as well as to a motor vehicle with a coupling device of this type.

A generic coupling device is for example known from DE 202 13 806 U1.

The coupling disclosed in the above designated utility model comprises a housing, an adapter and a retaining element. The adapter is inserted into the housing and is fixed in it. The retaining element is pushed into the adapter and is held axially and rotationally rigidly by it in the inserted state. For this purpose, a number of elastic tongues are provided on the retaining element, which are pressed together when the retaining element is pushed into the adapter. In the mounted state the tongues are splayed but and engage behind recesses formed in the adapter so that the adapter and the retaining element are joined in a positive locking manner.

On the inside of the tongues of the retaining element claw-type, elastic projections are provided, which in the mounted state engage behind the collar of a pipe or sleeve inserted into the coupling, so that the pipe or the sleeve is fixed axially in the coupling.

The known coupling has the disadvantage that, for example, once mounted, a damaged pipe cannot be replaced or only with great difficulty.

The object of the invention is to provide a coupling device for connecting pipes, which permits a pipe to be released from the coupling as required, wherein the secure fixing of the pipe in the coupling during operation is retained. Furthermore, a motor vehicle with this type of coupling is also proposed.

According to the invention, the object outlined above is resolved by a coupling device for the connection of pipes with a retaining device, which comprises an outer part and an inner part arranged within the outer part, wherein the outer part and the inner part can move relative to one another and in the longitudinal direction of the retaining device between a locking position and a release position. Furthermore, according to the invention at least one wedge surface, arranged sloping with respect to the longitudinal axis of the retaining device, is provided on the outer part, the said wedge surface interacting with at least one complementarily formed wedge surface provided on the inner part.

With regard to the motor vehicle the object outlined above is resolved by the subject matter of claim 20.

The invention has the advantage that the longitudinally displaceable arrangement of the outer part and of the inner part relative to one another facilitates bringing the retaining device into a locking position or release position, in which the pipe is held (locking position) or can be pulled out of the coupling device (release position). The coupling device according to the invention thus facilitates the easy replacement of, for example, damaged pipes.

Moreover, the invention has the advantage that the retaining device is automatically positively latched when the coupling device is deformed by an accident. To achieve this, at least one wedge surface, arranged sloping with respect to the longitudinal axis of the retaining device, is provided on the outer part, the said wedge surface interacting with at least one complementarily formed wedge surface provided on the inner part.

Due to a deformation of the coupling device essentially occurring transverse to the longitudinal axis of the retaining device, the outer part and the inner part are subjected to a force which essentially acts in the radial direction. The radially acting force causes the two complementarily formed wedge surfaces of the outer part and of the inner part to slide over one another, where, due to the slope in the longitudinal direction of the retaining device, a relative movement between the outer part and the inner part occurs. This longitudinal movement of the inner part or of the outer part caused by the deformation of the coupling device is the prerequisite that the retaining device can be brought into the locking position so that a pipe held in the coupling device is positively locked.

In this respect it is not important that the force caused by the deformation acts exactly in the radial direction. It is sufficient if a force is created by the deformation which leads to a displacement of the wedge surfaces in order to realise the required positive locking.

Preferably, the retaining device is arranged in a housing. Then with regard to the material selection, a functional separation can occur, wherein the comparatively simply produced housing consists of metal and thus offers robust protection against external influences. The retaining device can be manufactured in plastic, for example by injection moulding, wherein the individual functional elements of the retaining device, for example the wedge surfaces, can be manufactured efficiently.

According to a preferred embodiment of the invention, the outer part is fixed in the housing and the inner part can move into the locking position and release position, wherein the slope angle of the wedge surfaces is open in the direction of locking movement of the inner part. This means that the relative movement between the outer part and the inner part occurs in that the outer part is held spatially fixed in the housing and the inner part carries out the movement with respect to the outer part. The fixed support of the outer part in the housing can be established in a simple manner, for example, by a positive locking connection. The arrangement of the wedge surfaces such that the slope angle is open in the direction of locking movement of the inner part has the effect that the inner part is moved into the locking position when the outer part is spatially fixed and the coupling device is deformed.

The at least one wedge surface provided on the inner part can be formed on an end at the rear, in the direction of locking movement of the inner part, of at least one longitudinal rib formed on the inner part. The formation of longitudinal ribs with wedge surfaces provided at the end leads to a rugged and strong design of the inner part so that the inner part also largely retains its original shape even with greater deformation forces. In addition, through the use of longitudinal ribs a compact construction can be realised with comparatively little material.

The inner part can comprise two, three or four longitudinal ribs, each of which is formed on a wedge surface. Consequently, an even application of force on the inner part is achieved in the longitudinal direction.

In a further preferred embodiment of the invention the at least one wedge surface provided on the outer part is formed on an end, at the rear in the direction of locking movement of the inner part, of at least one longitudinal groove in which the at least one longitudinal rib can be moved by sliding displacement. This embodiment has the advantage that the longitudinal rib and the groove fulfil a double function. On one hand the longitudinal rib and groove, which engage one another, provide guidance of the inner part in the longitudinal direction of the retaining device. Additionally, the longitudinal rib and the groove facilitate the positive locking of the coupling device due to the wedge surface formed in each case at the rear end of the longitudinal rib or groove.

Preferably the number of longitudinal grooves provided corresponds to the number of longitudinal ribs.

In a further preferred embodiment of the invention the outer part comprises at least one actuation means for fixing the inner part, wherein the actuating means is arranged in the region of an opening provided in the housing. This embodiment has the advantage that the movable inner part can be held in a desired position, in particular in the release position, wherein pulling the pipe off is facilitated. The constructive design freedom is increased through the formation of an opening provided in the housing, through which the actuating means is accessible.

In addition, the security against unintentional release of the coupling device is increased in that for decoupling two separate functions of the coupling device are fulfilled; that is, the coupling device must be brought into the release position and the actuating means must be activated. This means that the coupling device only releases the pipe which it holds when the inner part is moved into the release position, for example by pressing the coupling device and the pipe together axially, and the actuating means is activated so that the inner part is fixed. The coupling device can thus be arranged such that unlocking of the pipe held in the coupling device is only possible when both functions (release position, activation of the actuating means) are fulfilled.

Preferably, provision is made that a housing section is formed cylindrically at least in the region of the retaining device, whereby the opening is arranged in the shell area of the cylindrical housing section. In this way the actuation device can be simply subjected manually to a radial pressure.

The actuating means can comprise at least one radially movable button, which can be brought to engage the inner part, in particular in the release position, through positive locking or through friction. The button can be brought to connect in a simple manner to the inner part so that it is held.

In this regard, the button can comprise a profile, in particular a projection or a recess, and the inner part a matching counter profile, in particular a recess or a projection, which are arranged opposite one another in the release position and can be brought into engagement by pressing the button. The formation of the profile on the button as well as the counter profile on the inner part facilitates an effective and firm fixing of the inner part through positive locking.

In a further preferred embodiment the inner part comprises a retaining element with two concentrically arranged and spaced annular sections, which are connected by webs arranged in the longitudinal extension of the retaining device, wherein the counter profile is formed in at least one of the webs. The webs arranged in the longitudinal extension of the retaining device improve the axial stability of the inner part, which is constructed compactly through the formation of the counter profile in at least one of the webs.

Furthermore, one surface of the web in which the counter profile is formed, can be recessed radially inwards in the region of the counter profile, so that a free space between the inner part and the outer part is formed above the web surface. This prevents the outer part profile provided on the button from colliding with the inner part when the inner part is axially displaced.

In a further preferred embodiment of the invention the housing comprises an opening through which a sleeve with at least one collar can be introduced into the housing and can be locked with the retaining device, wherein the diameter of the opening is matched to the diameter of the collar such that the collar engages behind an edge of the opening when the housing is deformed. The advantage of this embodiment is that with a deformation of the housing, for example due to an accident, the positions of the collar on the sleeve and the edge of the opening are displaced such that the opening and the collar are arranged eccentrically to one another. Through suitable matching of the diameter of the opening and of the collar, wherein the diameter of the opening is only slightly larger than the diameter of the collar, the situation is attained in which the collar engages behind the edge so that the pipe or the sleeve is locked in the coupling. The same effect is achieved through a deformation of the opening, wherein similarly with suitable matching of the diameters the collar engages behind the edge.

Consequently, in an advantageous manner additional security against withdrawal of the pipe from the coupling device is provided.

In this regard the housing in the region of the retaining device can be formed cylindrically and bent inwards to form the opening at its end. In this way the diameter of the opening can be easily set, referred to the diameter of the collar.

It has proven practicable if the diameter of the opening is greater than the diameter of the collar by an amount of 0.1 to 1 mm, in particular 0.4 to 0.8 mm.

The inner part can comprise at least one catch with a locking element arranged radially outwards and the outer part can comprise at least one limit stop, wherein the locking element and the limit stop interact in the locking position and are parted in the release position. The parting of the locking element and the limit stop occurs through a longitudinal displacement of the inner part with respect to the outer part in the direction of the release movement.

Advantageously, through the interaction of the locking element arranged radially outwards with the limit stop, the catch is held firm in the radial direction, wherein the locking function of the coupling device is fulfilled.

The at least one catch can comprise a carrier with a limit stop arranged radially inwards, which is arranged opposing the direction of locking movement of the inner part. In this respect the carrier fulfils a double function, because the collar provided on the sleeve or on the pipe pushes against the limit stop arranged radially inwards, for example due to a withdrawal movement, wherein the inner part is moved with respect to the stationary outer part in the longitudinal direction and in fact into the locking position of the inner part. Also, the limit stop of the carrier, arranged radially inwards, fixes the collar of the sleeve in the locking position so that further axial movement, in particular a withdrawal, of the sleeve, is prevented.

It has proven advantageous if the catch is formed to be sprung radially, wherein the insertion or release of the sleeve or the pipe is made easier.

By way of example, the invention is explained in more detail in the following with reference to the enclosed schematic drawings.

The following are illustrated:

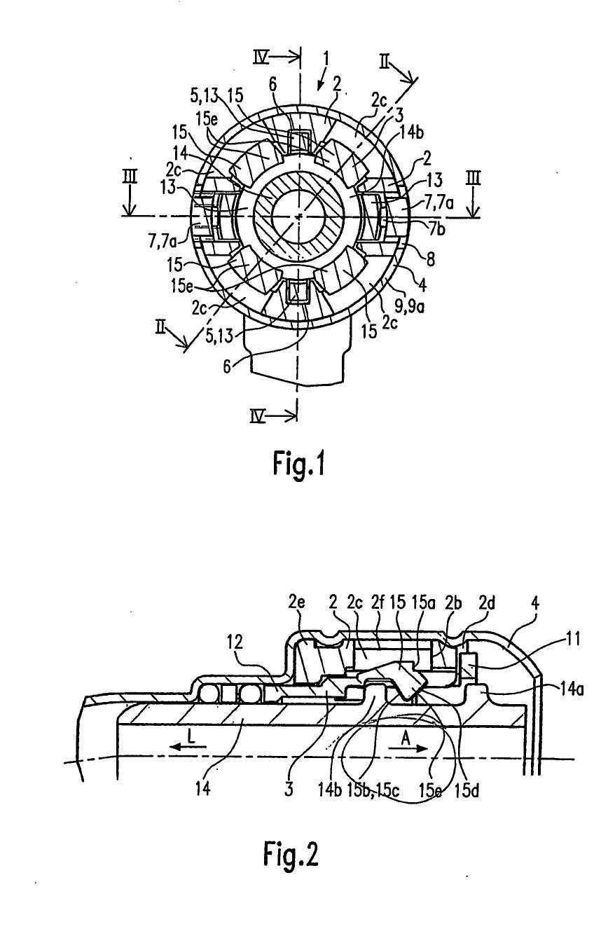

FIG. 1 a cross-section of an embodiment of a coupling device according to the invention in which a sleeve is inserted;

FIG. 2 a section of the embodiment according to FIG. 1 along the line II-II;

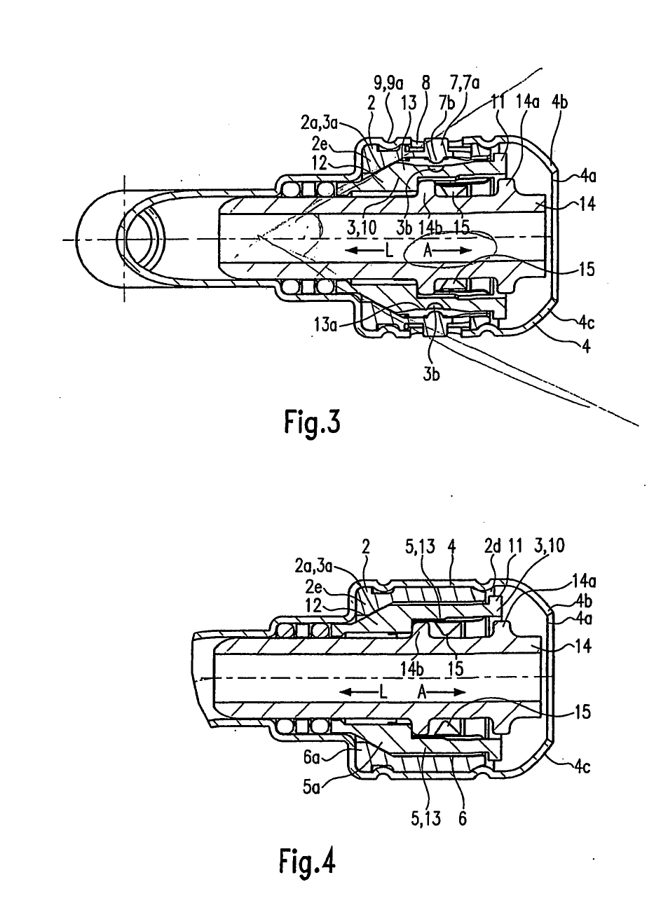

FIG. 3 a section of the embodiment according to FIG. 1 along the line III-III;

FIG. 4 a section of the embodiment according to FIG. 1 along the line IV-IV;

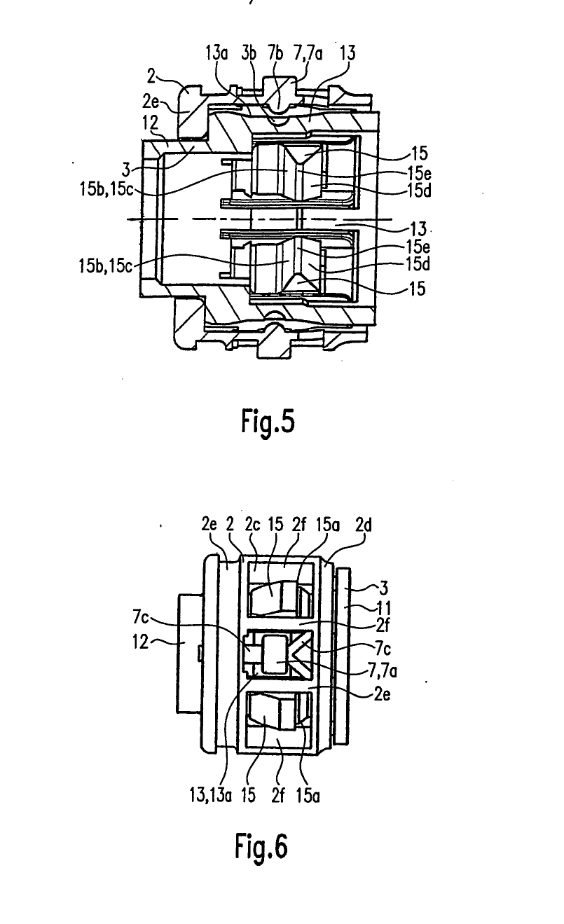

FIG. 5 a section similar to that in FIG. 3 without the sleeve for clarification of the actuating means;

FIG. 6 a side elevation of the mounted outer and inner parts of the embodiment according to FIG. 1;

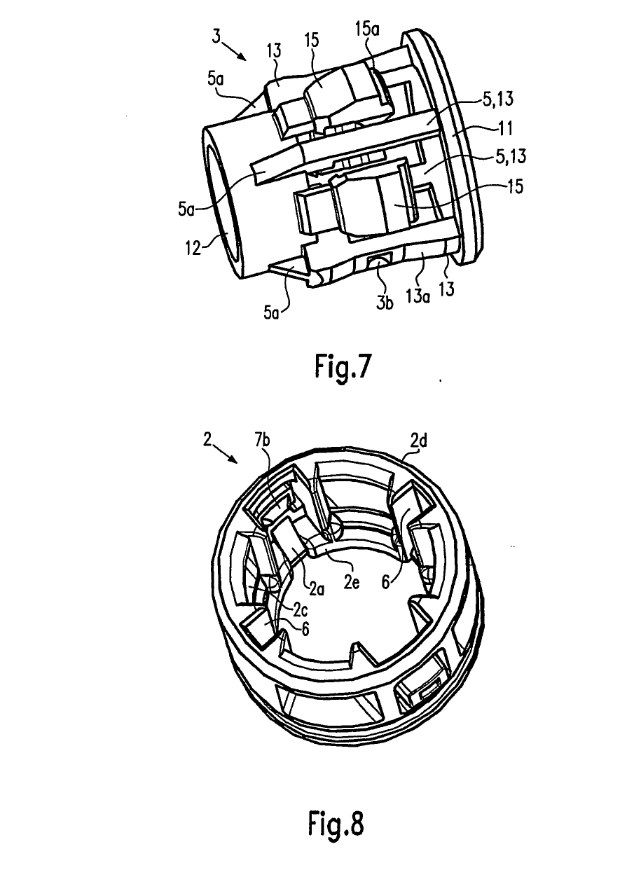

FIG. 7 a perspective view of the inner part;

FIG. 8 a perspective view of the outer part;

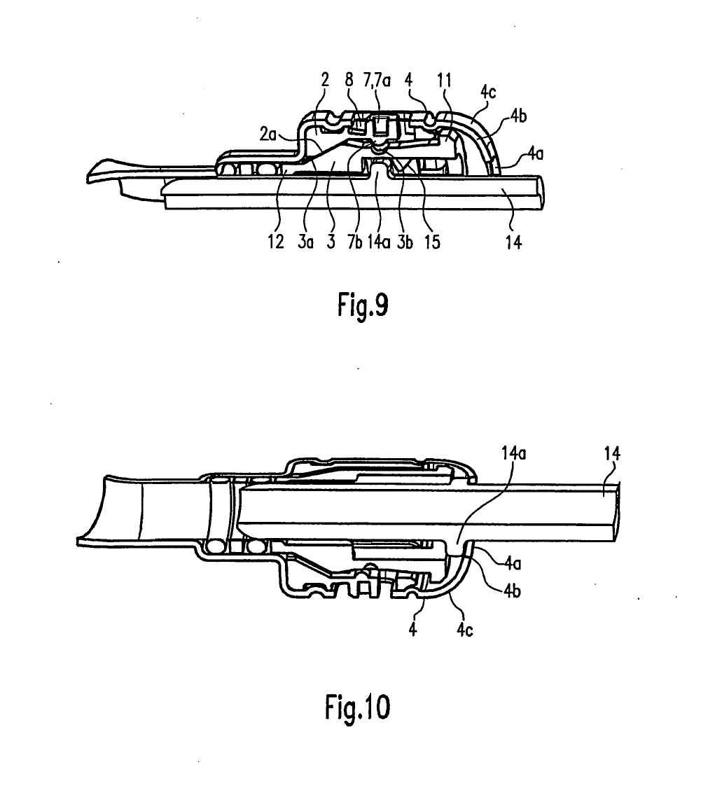

FIG. 9 a perspective view of the longitudinally sectioned embodiment according to FIG. 1 in the undeformed state;

FIG. 10 the view of the embodiment according to FIG. 9 in the deformed state;

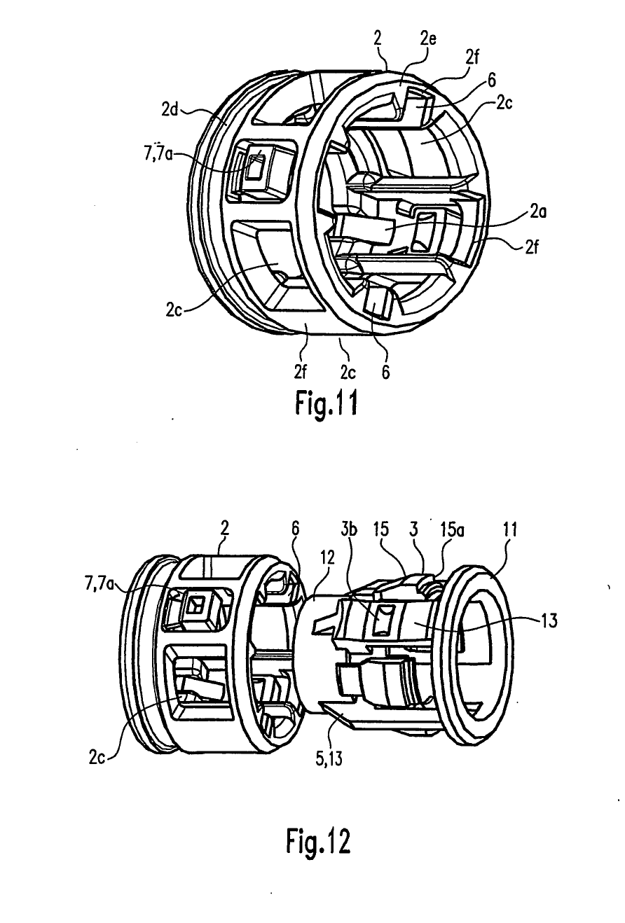

FIG. 11 a perspective view of the outer part with safety hooks and

FIG. 12 an exploded view of the outer part and the inner part without wedge surfaces for clarification of the actuating means and the associated counter profile.

FIG. 1 shows an embodiment of the coupling device according to the invention with the most important components, which can be used for the connection of fluid pipes, in particular in the field of the automotive industry. This coupling device is also designated as a plug coupling or quick coupling (Quick Connector).

As shown in FIG. 1, the coupling device has a retaining device 1, which comprises an outer part 2 and an inner part 3 which is arranged in the outer part 2. The outer part 2 acts as an adapter which is fixed in the housing 4. The inner part 2 can be moved in the longitudinal direction of the coupling device and can move into a release position and a locking position. The inner part 3 acts as a retaining element 10 for a sleeve 14 or an appropriately profiled pipe end, which is inserted into the inner part 3. To lock the sleeve 14 the inner part 3 is moved in the direction of locking movement labelled with A. For release, the inner part 3 is moved in the direction of releasing movement labelled with L.

The inner part 3 is constructed as follows:

As shown in particular in FIG. 7, the inner part 3 has two annular sections 11, 12 spaced concentrically from one another, wherein the annular section 12 remote from the insertion end (left end of the coupling device according to FIG. 7) is wider than the annular section 11 arranged closer to the insertion end. The two annular sections 11, 12 are joined together by webs 13 which are arranged in the longitudinal direction of the coupling device. The webs 13 form longitudinal ribs 5 which are equidistantly spaced on the circumference of the annular inner part 3.

The annular sections 11, 12 and the webs 13 or longitudinal ribs 5 are also illustrated in FIGS. 2 to 4 and 6 in a longitudinal section.

In FIGS. 3, 4 and 7 it can be seen that the ends 5a of the longitudinal ribs 5 remote from the insertion end are bevelled and each forms a wedge surface 3a. The wedge surface 3a is thus provided on the rear end 5a of each longitudinal rib 5 in the direction of locking movement A. The slope angle of the wedge surface 3a, i.e. the angle between the wedge surface 3a and the longitudinal axis of the coupling device is open in the direction of locking movement A. The slope angle is approx. 30° and can be varied in the range from 5° to 45° including all intermediate values within these limits. Depending on the length or diameter of the coupling device other range limits of the slope angle, in particular tighter range limits, may prove practicable.

The longitudinal ribs 5 terminating in the wedge surfaces 3a are furthermore illustrated in FIGS. 3 and 4 in a longitudinal section.

The number of four webs 13 can also be varied. It is also possible to use only two webs 13 and in the extreme case just one web 13. A larger number of webs 13 is also possible.

In FIG. 1 it can also be seen that webs 13 formed as longitudinal ribs 5 have an essentially rectangular cross-section with essentially equally long edges. The two webs 13, arranged between the longitudinal ribs 5 and which in FIG. 1 are arranged on the section axis III-III, have edges in the circumferential direction which are longer than the corresponding edges of the ribs 5. The webs 13 arranged between the longitudinal ribs 5 are therefore wider than the longitudinal ribs 5, as can also be seen in FIG. 7.

The wider webs 13, similar to the longitudinal ribs 5, are provided with wedge surfaces 3a, which are in each case arranged at the rear ends of the wide webs 13 in the direction of locking movement A (refer to FIG. 3). In FIG. 7 it can also be seen that the wedge surfaces 3a are spaced from the wide webs 13 and do not extend over the full width of the webs 13. The width of the wedge surfaces 3a, which are joined to the wide webs 13, essentially corresponds to the width of the wedge surfaces 3a, which are formed on the longitudinal ribs 5.

A recess in the form of a counter profile 3b is formed in the surface of the wide webs 13 which is arranged radially outwards. This counter profile 3b is provided for engagement with a profile 7b provided on a button 7a and facilitates the axial fixing of the inner part 3 in the release position. As can be seen particularly well in FIG. 3, the surface 13a of the wide webs 13 in the region of the counter profile 13b is somewhat recessed radially inwards and forms an indentation in which the protruding profile 7b can freely move when the button 7a is not activated.

A catch 15, which is elastically spring mounted on the wider annular section 12, is provided in the free space between each wide web 13 and each longitudinal rib 5. The catches 15 each extend in the longitudinal direction of the coupling device and are spaced equidistantly on the circumference of the annular section 12.

Each catch 15 has a locking element 15a and a carrier 15b arranged opposite the locking element 15a, as illustrated in FIG. 2. The locking element 15a is arranged on the outer side of the catch 15 and is formed as an edge or shoulder spaced radially outwards. The shoulder of the locking element 15a has a radially extended shoulder face and an axially extended shoulder face. The shoulders thus form an angle open to the insertion end of the coupling device (right end in FIG. 2). The locking element 15a can also be seen in FIGS. 6 and 7.

On the inside of the catch 15 the carrier 15b is provided, which has a limit stop 15c arranged radially inwards. The limit stop 15c comprises a surface sloped with respect to the longitudinal axis of the coupling device, the slope angle of which is open in the direction of releasing movement L. The slope angle of the surface of the limit stop 15c is taken to mean the angle between the longitudinal axis of the coupling device and the surface of the limit stop 15c.

The catch 15 also has a further surface 15d arranged radially inwards and sloped with respect to the longitudinal axis of the coupling device, the slope angle of said surface being open in the direction of locking movement A, as illustrated in FIG. 2. The limit stop 15c or the sloped surface of the limit stop 15c and the further sloped surface 15d form a wedge-shaped protrusion 15e, which is illustrated in FIG. 2.

The respective wedge-shaped protrusions 15e of the catches 15 are arranged on an imaginary circular diameter which is smaller than the outer diameter of the collar 14b of the sleeve 14 illustrated in FIG. 2. In the mounted state the wedge-shaped protrusion 15e of the catch 15 thus engages behind the collar 14b.

The wedge-shaped protrusion 15e of the catch 15 is also illustrated in FIG. 5. The embodiment illustrated in FIG. 5 deviates from the embodiment according to FIG. 1 in that the wedge surfaces 3a are only provided on ribs 5.

The construction of the outer part 2 is explained in more detail in the following.

FIG. 6 shows that the outer part 2 comprises two annular sections 2d, 2e which are arranged concentrically and spaced from one another. The two annular sections 2d, 2e each have a groove so that the two annular sections 2d, 2e can be crimped with the housing 4, as illustrated in FIGS. 2 to 4.

The two annular sections 2d, 2e are joined by longitudinal webs 2f, which are arranged spaced equidistantly on the circumference of the two annular sections 2d, 2e. Consequently, in each case a through-aperture 2c is formed between two webs 2f, which in the mounted state is assigned in each case to a catch 15, which partially protrudes into the respective through-aperture 2c, as can be seen for example in FIG. 2.

The webs 2f are formed on their inside, i.e. pointing radially inwards, with a longitudinal groove 6, the width and depth of which are matched to the dimensions of the longitudinal ribs 5 of the inner part, so that the longitudinal ribs 5 can move with a sliding displacement in the longitudinal grooves 6. The arrangement of the longitudinal ribs in the longitudinal grooves 6 can be particularly easily seen in FIG. 1.

As also illustrated in FIG. 4, each longitudinal groove 6 has at its rear end 6a in the direction of locking movement A of the inner part 3 a wedge surface 2a. The wedge surface 2a is formed complementarily to the wedge surface 3a of the longitudinal rib 5 formed on the inner part 3. This means that the slope angle of the wedge surface 2a of the outer part 2 corresponds to the slope angle of the wedge surface 3a of the inner part 3. The wedge surfaces 2a, 3a thus lie flat, one on top of the other, in the release position.

Also, the outer part 2 is provided with actuating means 7, which, as illustrated in FIGS. 1 and 3, is formed as the button 7a. With the embodiment illustrated in FIGS. 1 and 3 two buttons 7a, each of which are formed essentially identically, are provided offset by 180°. This arrangement of the buttons 7a facilitates a simple and economically favourable manual activation. It is also possible to provide only one button 7a.

The buttons 7a are each fitted to a longitudinal side of the outer part 2 and can be moved in the radial direction (FIG. 3). For this, each button 7a is joined by webs 7c to the two annular sections 2d, 2e of the outer part 2, as illustrated in FIG. 6. In this respect the webs 7c connecting the button 7a to the annular section 2d at the insertion end are arranged in a V-shape. The web 7c joining the button 7a to the more remote annular section 2e is somewhat wider than the V-shaped webs 7c. The webs 7c are elastic and facilitate a displacement of the button 7a when they are actuated in the radial direction of the outer part 2.

FIGS. 1 and 3 also show that the button 7a also has a profile 7b in the shape of a protrusion arranged radially inwards. The contour of the profile 7b essentially corresponds to the contour of the counter profile 3b formed on the inner part 3, as illustrated in FIG. 3. In the release position the profile 7b of the button 7a and the counter profile 3b of the inner part 3 are arranged opposite one another so that on actuation of the button 7a, the profile 7b engages the counter profile 3b and the inner part 3 locks with the outer part 2. Consequently, an axial movement of the inner part 3 is prevented and the inner part 3 is held in the release position.

It is also possible to form the profile 7b and the counter profile 3b in other ways. For example, on the inner part 3 a protrusion can be provided and a complimentarily shaped recess provided on the surface of the button 7a arranged radially inwards, which can be brought into engagement with one another when the button 7a is actuated. Furthermore, instead of the positive locking joint between the outer part 2 and the inner part 2 described above, it is also possible to produce a friction joint on actuation of the button 7a, similarly preventing an axial movement of the inner part 3.

FIGS. 3 and 8 show that the annular section 2e, at the rear in the direction of locking movement and in the region of the actuating means 7, i.e. in axial alignment with the button 7a, has a wedge surface 2a. This wedge surface 2a is formed complementary to the wedge surface 3a on the inner part 3, as illustrated in FIG. 3. The axial arrangement of the wedge surface 2a with regard to the button 7a is illustrated in FIG. 8. This means that the rear annular section 2e in the direction of locking movement A of the outer part 2 narrows in the direction of locking movement A, i.e. in the direction of the button 7a. The slope angle of the wedge surface 2a of the outer part 2 corresponds to the slope angle of the complementary wedge surface 3a of the inner part 3.

It is also possible to provide only the longitudinal grooves 6 positioned between the buttons 7a with corresponding wedge surfaces 2a and to form the rear annular section 2e in the direction of locking movement of the outer part 2 with a limit stop surface extended transverse to the longitudinal direction of the outer part 2, as illustrated in FIG. 5.

The outer part 2 can have additional security against failure on deformation of the coupling device due to an accident. This additional security comprises a latching hook 2g, which is provided on one of the webs 2f between two through-apertures 2c and which protrudes radially inwards. The latching hook 2g engages behind the collar 14a of a sleeve 14 or the end of a pipe inserted into the coupling device and also prevents the pipe from being able to be withdrawn from the coupling device when it is deformed. For this purpose, the latching hook 2g essentially has a wedge shape, wherein a diagonal surface of the latching hook 2g essentially extends in the axial direction and narrows in the direction of locking movement A, as illustrated in FIG. 11. Due to this, the collar 14a of the sleeve 14 can be easily pushed over the latching hook 2g when it is inserted into the coupling device. The latching hook 2g also comprises a limit stop surface arranged essentially perpendicular to the longitudinal direction of the outer part 2, the said limit stop surface interacting with the collar 14a of the sleeve 14 and preventing its withdrawal.

The design of the housing 4 is explained in the following.

FIGS. 2 to 4 and 10 show that the housing 4 has an opening 4a for inserting a sleeve 14 or an end of a pipe into the coupling device, wherein the diameter of the insertion opening 4a is matched to the diameter of the collar 14a of the sleeve 14 such that the collar 14a engages behind an edge 4b of the opening 4a when the housing 4 is deformed so that a separation of the pipe and the coupling device is prevented when the housing 4 is deformed. To achieve this, the housing 4, cylindrically formed in the region of the retaining device 1, is bent radially inwards at its end 4c on the insertion end. The diameter of the insertion opening 4e is slightly larger than the diameter of the collar 14a. In particular, the diameter of the opening 4a is greater than the diameter of the collar 14a by the amount from 0.1 to 1 mm, in particular from 0.4 to 0.8 mm.

In the undeformed state the radial outer side of the collar 14a and the opening 4a of the housing 4 are arranged concentrically so that the collar 14a can be introduced into the housing 4 through the opening 4a. With a deformation of the housing 4 the concentric arrangement of the collar 14a and the opening 4a is modified so that the collar 14a and the housing 4a are arranged eccentrically to one another. In this way the collar 14a engages at least partially behind the edge 4b of the opening 4a, producing effective protection against withdrawal.

Due to the slight difference in diameter between the opening 4a and the collar 14a, a slight deformation of the end 4c on the insertion end in the region of the opening 4a also leads to the desired effect, because the opening 4a loses its circular cross-section so that the circular profile of the collar 14a engages behind the edge 4b of the deformed opening 4a in some places and withdrawal of the sleeve 14 or the end of the pipe from the coupling device is prevented.

The arrangement of the sleeve 14 and of the housing 4 in the undeformed state and the deformed state are illustrated in FIGS. 9 and 10. In particular FIG. 10 shows that the collar 14a engages behind the edge 4b of the opening 4a in the deformed state of the housing 4, suppressing an axial movement of the sleeve 14, i.e. withdrawal of the sleeve 14 from the coupling device.

In the region of the retaining device the housing 4 is formed with a cylindrical section 9, wherein two openings 8, radially offset by 180°, are provided in the shell area 9a of the section 9. In the mounted state the buttons 7a are arranged in these openings 8 and are thus accessible for actuation.

The housing 4 described above can be combined with a sleeve 14, which either has a collar 14a (FIGS. 9, 10) or two collars 14a, 14b (FIGS. 2 to 4). In the case of the sleeve 14 with only one collar 14a, the one collar 14a is used both for the actuation of the carrier 15b of the button 15 on the inner part 3 as well as for withdrawal protection in conjunction with the (deformed) edge 4b of the opening 4a of the housing 4. In the case of the sleeve 14 with two collars 14a, 14b the functions explained above are separated, wherein the rear collar 14b in the direction of locking movement A interacts with the carrier 15b of the catch 15 and the front collar 14a in the direction of locking movement A interacts with the (deformed) edge 4b of the opening 4a.

The elements described above are arranged in the mounted state as follows.

In the mounted state the sleeve 14 is inserted into the inner part 3 which is held in the outer part 2. The outer part 2 is firmly joined to the housing 4, for example by crimping. As illustrated in FIGS. 1, 2 and 6, the longitudinal ribs 5 of the inner part 3 are guided in the longitudinal grooves 6 of the outer part 2 for longitudinal displacement, wherein the catches 15 are arranged in the through-apertures 2c of the outer part 2 and partially protrude into them.

The catches 15 protrude in each case so far into the respective through-apertures 2c that the annular limit stop 2b of the outer part 2, in particular the edge of the limit stop 2b arranged radially inwards, can engage the locking element 15a. To achieve this, the edge of the limit stop 2b of the outer part 2 is arranged slightly wider radially outwards than the shoulder face of the limit stop 15 which extends in the longitudinal direction, as illustrated in FIG. 2. Consequently, the shoulder face of the locking element 15a extended in the radial direction and the limit stop face of the limit stop 2b, similarly extended in the radial direction, can come into contact, preventing a further axial movement of the inner part 3 in the direction of locking movement A.

Furthermore, one of the two collars 14a, 14b, namely the rear collar 14b in the direction of locking movement A is arranged in the direction of locking movement A behind the carrier 15b of the catch 15, as illustrated in FIG. 2.

The functioning principle of the coupling device is explained in the following:

The inner part 3 is brought into the locking position in that the sleeve 14 is displaced in the direction of locking movement A. In this way the collar 14b abuts against the carrier 15b of the catch 15, in particular against the sloping limit stop surface 15c. Due to the displacement of the sleeve 14 in the direction of locking movement A, the inner part 3 is carried along and also executes an axial movement in the direction of locking movement A. In this respect the spring force of the catch 15 should be set such that a radial deviation of the catch 15 due to the force transferred by the sleeve 14 in the direction of locking movement A onto the catch 15 does not occur. In the locking position the locking element 15a engages the limit stop 2b of the outer part 2. Here, the edge of the limit stop 2b of the outer part engages the shoulder-shaped locking element 15a so that both an axial movement of the inner part is prevented as well as a radial deviating movement of the catch 15. In this way the carrier 15b or the diagonal limit stop surface 15c of the catch 15 is locked both in the axial and in the radial direction so that withdrawal of the sleeve 14 from the coupling device is prevented.

Through displacement of the inner part 3 in the direction of releasing movement L, the locking element 15a of the catch 15 is released from the limit stop 2b of the outer part 2, facilitating an opening movement of the catch 15, directed radially outwards, in the respective through-aperture 2c of the outer part 2. The axial force necessary for displacing the inner part 3 into the release position can be introduced either directly into the inner part 3 or via the sleeve 14 into the inner part 3. Here, the collar 14b of the sleeve 14 abuts against a suitable limit stop of the inner part 3 and moves it by an appropriate movement of the sleeve 14 in the direction of releasing movement L into the coupling device. The release position is reached when the profile 7b provided on the button 7a and the counter profile 3b of the inner part 3 are arranged in opposing positions (FIG. 3) and the wedge surfaces 2a, 3a of the outer part 2 or of the inner part 3 are in contact (FIGS. 3, 4).

For releasing, the button 7a is actuated such that the profile 7b and the counter profile 3b are joined in a positive locking manner and an axial displacement movement of the inner part 3 is prevented so that it is held in the release position. Then the sleeve 14 can be withdrawn against the direction of releasing movement L, i.e. in the direction of locking movement A, from the coupling device without the inner part 3 being moved into the locking position. Due to the axial movement of the sleeve 14 the catches 15 are splayed out, wherein the collar 14b slides along the sloped limit. stop surface 15c of the carrier 15b. Once the collar 14b has overcome the wedge-shaped protrusion 15e of the catch 15, the said protrusion extending radially inwards, the sleeve 14 can be pulled without resistance from the coupling device.

During the positive locking of the coupling device, triggered by a deformation of the housing 4, the inner part 3 is displaced forcibly from the release position into the locking position and held there. For this, the wedge surfaces 2a of the outer part interact with the wedge surfaces 3a of the inner part. Due to the deformation of the housing 4, the annular sections 2e, at the rear in the direction of locking movement A, of the outer part 2 and 12 of the inner part 3 are subjected to a force acting essentially in the radial direction. Due to the wedge surface 2a, 3a sloped in the longitudinal direction of the coupling device, an axial force aligned in the direction of locking movement A is produced which forcibly displaces the inner part 3 into the locking position and fixes the inner part in the locking position.

With the described embodiment the outer part 2 is fixed in the housing 4 and arranged stationary with respect to the axially moving inner part 3. With this arrangement of the outer part 2 and of the inner part 3 the axial force directed in the direction of locking movement A is produced in that the slope angle of the wedge surfaces 2a, 3a is open in the direction of locking movement A of the inner part.

It is also possible to provide the inner part 3 stationary with respect to the outer part 2, i.e. firmly joined to the housing, wherein the outer part 2 is moved into the locking position. In this case the alignment of the slope angle of the wedge surfaces would need to be matched appropriately in order to produce an axial force acting in the direction of locking movement when the housing is deformed.

Generally the important thing is that a relative movement between the inner part 3 and the outer part can take place so that two different positions (release position and locking position) can be assumed.

Due to the matching of the diameter of the opening 4a of the end 4c of the housing 4 at the insertion end, additional withdrawal protection is produced which comes to bear when the positive locking described above fails. Since with a deformation of the housing 4, the opening 4a is also deformed so that the original circular cross-section of the opening 4a is modified, the situation is obtained where the collar 14a of the sleeve 14 engages behind the edge 4b of the opening 4a and prevents it sliding out from the coupling device (FIG. 10).

It has proven practicable if the inner part 3 has two webs 13 offset by 180° with longitudinal ribs 5 as well as two wider webs 13, similarly offset by 180°, each of which are provided with an actuating means 7. The wide webs 13 and the webs formed as longitudinal ribs 5 are each arranged offset by 90° to one another on the circumference of the inner part 3. The longitudinal grooves 6 of the outer part 2, assigned respectively, are matched to the dimensions of the longitudinal ribs or of the wide webs 13 and facilitate the longitudinally displaceable guidance of the inner part 3 in the outer part 2. A different number of webs 13, for example more than two webs 13 with the longitudinal ribs 5 or more than two wide webs 13 with actuating means 7, is possible.

It is also possible to only provide two wide webs 13, which are arranged offset by 180° on the circumference of the inner part 3. In this case the catches 15, each arranged on one side, can be connected to form a semicircular catch 15, so that the inner part 3 has two catches extending over a larger part of the circumference. The wedge surfaces 2a, 3a can only be provided on the longitudinal ribs 5 or only connected to the actuating means 7. The wedge surfaces 2a, 3a can correspond in their width to the width of the longitudinal ribs 5. It is also possible to form the wedge surfaces 2a, 3a with a larger width so that the wedge surfaces 2a, 3a are extended over a larger part of the circumference of the inner part 3.

The shape of the profile 7b on the button 7a can be varied as required, wherein it must be ensured that the profile 7b and the counter profile 3b can be brought into positive locking engagement in the inner part 3. Instead of fixing the inner part 3 with respect to the outer part 2 by a positive locking connection, axial fixing of the inner part can also take place through a frictional joint on actuation of the button 7a of the outer part 2.

The matching of the diameter of the opening 4a to the outer diameter of the collar 14a can occur through simple bending of the end 4c of the housing 4 on the insertion end. In this case the housing 4 is constructed in one piece. Instead of the single-part housing construction, the housing can also be constructed in two parts, wherein instead of the end 4c of the housing 4 being bent radially inwards, a suitable attachment is provided, which can be joined to the housing 4 and has an insertion opening matched with regard to the diameter.

The coupling device is suitable for connection to a sleeve 14 to which a pipe can be connected. The coupling device is also suitable for connecting to a suitably profiled end of a pipe.

Overall, it is important that the radial force produced by the deformation of the housing is split into a radial component and an axial component. This can generally be achieved in that one of the two complementarily formed wedge surfaces is replaced by an element having the same effect, so that only one wedge surface is provided. For example, the wedge surface 2a could be just provided on the outer part 2 and the wedge surface 3a of the inner part 3 could be replaced by a radial edge formed on the inner part 3, which is arranged in the region of the wedge surface 2a of the outer part 2.

It would also be possible to just provide the wedge surface 3a of the inner part 3 and instead of the wedge surface 2a of the outer part 2, to fit a protrusion in the region of the wedge surface 3a of the inner part 3, which is in contact with the wedge surface 3a of the inner part 3 in the release position.

In both cases due to the single wedge surface, the radial force introduced due to the deformation of the housing would be converted into an axially aligned force, which can be used for the displacement of the inner part into the locking position. In this case rather than a flat contact, a linear contact would arise between the wedge surface and the replacement element, which with regard to the stability of the overall arrangement is less advantageous than the flat pressing produced with the two wedge surfaces 2a, 3a. The effect of forcibly displacing the inner part 3 or the outer part 2 into the locking position could however be achieved also with the use of only one wedge surface.

The coupling device can be used in all fields in which fluid-bearing pipes are coupled together. The coupling device is in particular provided for the automotive industry, for example for joining fuel pipes.

1. Coupling device for connecting pipes with a retaining device, which has an outer part and an inner part arranged in the outer part, wherein the outer part and the inner part are movable with respect to one another between a locking position and a release position and in the longitudinal direction of the retaining device, wherein at least one wedge surface is provided, sloping with respect to the longitudinal axis of the retaining device, on the outer part, which interacts with at least one complementarily formed wedge surface provided on the inner part.

2. Coupling device according to claim 1, that wherein the retaining device is arranged in a housing.

3. Coupling device according to claim 2, wherein the outer part is fixed in the housing and the inner part can move into the locking position and release position, wherein the slope angle of the wedge surfaces is open in the direction of locking movement of the inner part.

4. Coupling device according to claim 1, wherein the at least one wedge surface provided on the inner part is formed on an end, at the rear in the direction of locking movement of the inner part, of at least one longitudinal rib formed on the inner part.

5. Coupling device according to claim 4, wherein the inner part has two, three or four longitudinal ribs, each of which is formed with a wedge surface.

6. Coupling device according to claim 4, wherein the at least one wedge surface provided on the outer part is formed on an end, at the rear in the direction of locking movement of the inner part, of at least one longitudinal groove, in which the at least one longitudinal rib can move for sliding displacement.

7. Coupling device according to claim 6, wherein a number of longitudinal grooves is provided corresponding to the number of longitudinal ribs.

8. Coupling device according claim 2, wherein the outer part comprises at least one actuating means for fixing the inner part, wherein the actuating means is arranged in the region of an opening provided in the housing.

9. Coupling device according to claim 8, wherein a housing section is formed cylindrically at least in the region of the retaining device, wherein the opening is arranged in the shell area of the cylindrical housing section.

10. Coupling device according to claim 8, wherein the actuating means has at least one radially movable button, which can be brought into engagement in a positive locking or frictional manner with the inner part, in the release position.

11. Coupling device according to claim 10, wherein the button can have a profile of a projection or a recess, and the inner part can have a matching counter profile of a recess or a projection, which are arranged opposite one another in the release position and can be brought into engagement by actuating the button.

12. Coupling device according to claim 11, wherein the inner part comprises a retaining element with two concentrically arranged and spaced annular sections, which are joined by webs arranged in the longitudinal direction of the retaining device, wherein the counter profile is formed in at least one of the webs.

13. Coupling device according to claim 12, wherein a surface of the web, in which the counter profile is formed, is reduced radially inwards in the region of the counter profile.

14. Coupling device according to claim 1, wherein the housing as an opening, through which a sleeve with at least one collar can be introduced into the housing and which can be locked with the retaining device, wherein the diameter of the opening is matched to the diameter of the collar such that the collar engages behind an edge of the opening when the housing is deformed.

15. Coupling device according to claim 14, wherein the housing in the region of the retaining device is formed cylindrically and bent radially inwards to form the opening at its end.

16. Coupling device according to claim 14, wherein the diameter of the opening is greater than the diameter of the collar by an amount of 0.1 to 1 mm, in particular 0.4 to 0.8 mm.

17. Coupling device according to claim 1, wherein the inner part has at least one catch with a locking element arranged radially outwards and the outer part has at least one limit stop, wherein the locking element and the limit stop interact in the locking position and are parted in the release position.

18. Coupling device according to claim 17, wherein the at least one catch has a carrier with a limit stop arranged radially inwards, which is arranged against the direction of locking movement of the inner part.

19. Coupling device according to claim 18, wherein the at least one catch is formed sprung radially.

20. Motor vehicle with a coupling device according to claim 1.

21. A coupling device for connecting pipes with a retaining device, comprising:
an outer part; and
an inner part, the outer part and the inner part being movable with respect to one another between a locking position and a release position and in the longitudinal direction of the retaining device, wherein at least one wedge surface is provided, sloping with respect to the longitudinal axis of the retaining device, on the outer part, which interacts with at least one complementarily formed wedge surface provided on the inner part.
